(19) United States
(12) Patent Application Publication
(10) Pub. No.: US 2026/0014985 A1
(43) Pub. Date: Jan. 15, 2026

(54) TRAVEL SUPPORT DEVICE

(71) Applicants: TOYOTA JIDOSHA KABUSHIKI KAISHA, Toyota-shi (JP); DENSO CORPORATION, Kariya-city (JP)

(72) Inventors: Soichi YOSHINO, Ichikawa-shi (JP); Ryuta Hashimoto, Tokyo-to (JP); Takahiro Seta, Yokohama-shi (JP); Takuo Kaneko, Tokyo-to (JP)

(73) Assignees: TOYOTA JIDOSHA KABUSHIKI KAISHA, Toyota-shi (JP); DENSO CORPORATION, Kariya-city (JP)

(21) Appl. No.: 19/236,348

(22) Filed: Jun. 12, 2025

(30) Foreign Application Priority Data
Jul. 9, 2024 (JP) 2024-110220

(51) Int. Cl. B60W 30/095; B60W 50/00; G08G 1/00

(52) U.S. Cl. CPC B60W 30/0956; B60W 50/00; G08G 1/22; B60W 2554/801; B60W 2554/804; B60W 2556/45

(57) ABSTRACT

A travel support device according to the present disclosure supports platooning of vehicles. The travel support device includes one or more processors. The one or more processors are configured to: acquire, from a target vehicle, travel preference information indicating a preference of an occupant regarding vehicle traveling and including travel pattern preference information on a desired travel pattern; and based on the acquired travel preference information, execute vehicle train formation support processing of supporting formation of a vehicle train that performs the platooning. The vehicle train formation support processing includes presenting the vehicle train as a candidate for cooperatively performing the platooning, to the occupant of the target vehicle through a human machine interface device of the target vehicle, when a degree of match of the travel preference information between the vehicle train and the target vehicle is higher than a first threshold value.

### CROSS-REFERENCES TO RELATED APPLICATION

The present disclosure claims priority under 35 U.S.C. § 119 to Japanese Patent Application No. 2024-110220, filed on Jul. 9, 2024, which is incorporated herein by reference in its entirety.

### BACKGROUND

### Technical Field

The present disclosure relates to a technique for supporting platooning of vehicles.

### Background Art

JP 2020-042649 A discloses a driving assistance device that helps vehicles merge into a vehicle group including a plurality of vehicles traveling in a row. The driving assistance device acquires the most frequent vehicle speed indicating a speed preferred by the driver of a vehicle and provides the driver with information on the vehicle group traveling at the most frequent vehicle speed or a speed close to the most frequent vehicle speed.

JP 2022-032673 A discloses a travel assistance system that assists a convoy travel. The travel assistance system includes an in-vehicle device of a following vehicle, and the in-vehicle device notifies a vehicle of a following target permitted to follow together with a matching distance matching a route to a destination. JP 2019-179322 A discloses a convoy control device that separates a target vehicle from a convoy and joins a target vehicle to a convoy for the purpose of optimizing the number of vehicles constituting the convoy.

JP 2013-084147 A discloses an HMI device mounted on a vehicle traveling in a convoy and having a screen for displaying various kinds of information (e.g., acceleration and deceleration states of other vehicles in the convoy and relative positions of vehicles in the convoy). JP 2023-033359 A discloses a vehicle management device that acquires a congestion degree of a road on which platooning is performed and sets a reference of the number of vehicles that form the platooning or a length of the platooning based on the acquired congestion degree. Further, JP 2023-037371 A discloses a power supply system that contributes to expanding the application of convoy travel by proving an incentive to a vehicle to travel as the lead vehicle of the convoy.

### SUMMARY

A technique that enables vehicles to perform platooning while more sufficiently satisfying the preferences of the occupants regarding vehicle traveling is desired.

A travel support device according to the present disclosure supports platooning of vehicles. The travel support device includes one or more processors. The one or more processors are configured to: acquire, from a target vehicle, travel preference information indicating a preference of an occupant regarding vehicle traveling and including travel pattern preference information on a desired travel pattern; and based on the acquired travel preference information, execute vehicle train formation support processing of supporting formation of a vehicle train that performs the platooning. The vehicle train formation support processing includes presenting the vehicle train as a candidate for cooperatively performing the platooning, to the occupant of the target vehicle through a human machine interface device of the target vehicle, when a degree of match of the travel preference information between the vehicle train and the target vehicle is higher than a first threshold value.

According to the present disclosure, formation of a vehicle train that performs the platooning is supported in consideration of the desired travel pattern as the preference of an occupant regarding vehicle traveling. Therefore, the platooning can be performed while more sufficiently satisfying the preference.

### BRIEF DESCRIPTION OF THE DRAWINGS

FIG. 1 is a conceptual diagram used to describe an overview of a travel support system according to an embodiment;

FIG. 2 is a block diagram showing an example of a configuration of a vehicle and a management server according to an embodiment;

FIG. 3 is a flowchart showing an example of a flow of preference information acquisition processing and vehicle train formation support processing according to an embodiment;

FIG. 4 is a flowchart showing a first example of a flow of the vehicle train formation support processing in step S3;

FIG. 5 is a supplementary diagram regarding a degree of match Dm2 of destination preference information;

FIG. 6 is a flowchart showing a second example of a flow of the vehicle train formation support processing in step S3;

FIG. 7 is a flowchart showing an example of a flow of the vehicle train formation support processing accompanied by first vehicle train reconstitution processing; and

FIG. 8 is a flowchart showing an example of a flow of the vehicle train formation support processing accompanied by second vehicle train reconstitution processing.

### DETAILED DESCRIPTION

Embodiments of the present disclosure will be described with reference to the accompanying drawings.

### 1. Overview of Travel Support System

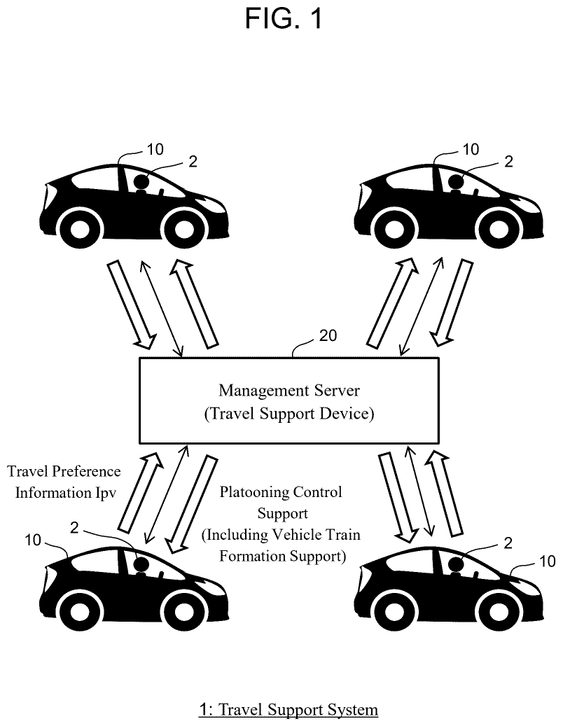

FIG. 1 is a conceptual diagram used to describe an overview of a travel support system 1 according to the present embodiment. The travel support system 1 is a system that supports platooning of a vehicle 10. The travel support system 1 includes a plurality of vehicles 10 (10_1 to 10_N: N is an integer greater than or equal to 2) and a management server (i.e., central server) 20. Each of the plurality of vehicles 10 is a target of the platooning support by the travel support system 1 (the “target vehicle” according to the present disclosure). For example, the platooning is performed on an exclusive road for automobiles, such as an expressway.

The management server 20 can communicate with each of the plurality of vehicles 10. The management server 20 supports formation of a vehicle train (i.e., a vehicle queue or a convoy) T for platooning by vehicles 10 having similar preferences (travel preferences) of occupants 2 regarding vehicle traveling. That is, the “vehicle train” mentioned here refers to a train of vehicles that perform platooning on a road. Also, the management server 20 controls the traveling of the formed vehicle train T (i.e., the platooning). For example, the management server 20 controls acceleration, deceleration, and lane change of the formed vehicle train T. In addition, the management server 20 corresponds to an example of the “travel support device” according to the present disclosure.

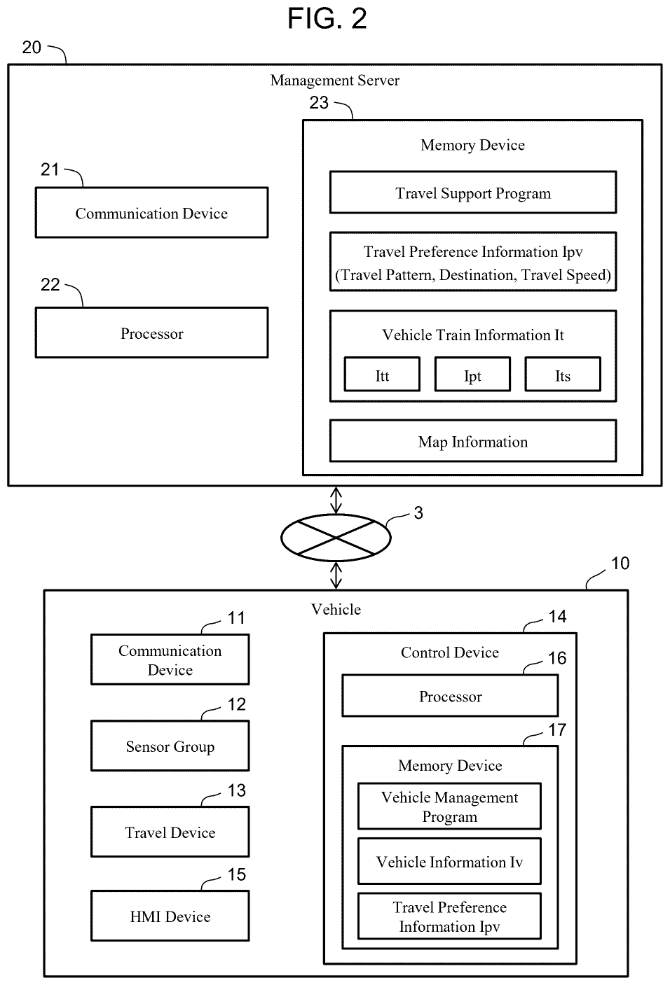

The vehicle 10 may be a manually driven vehicle in which the occupant 2 drives the vehicle 10 as a driver. In the example of the manually driven vehicle, the management server 20 transmits an instruction regarding the platooning (for example, an instruction of travel speed, acceleration, deceleration, or lane change of the vehicle train T) to, for example, an HMI device 15 (see FIG. 2) of each of the vehicles 10 constituting the vehicle train T. As a result, the driver 2 of each vehicle 10 drives the subject vehicle 10 in accordance with the instruction. Further, the instruction may be transmitted only to the lead vehicle 10 of the vehicle train T, for example. As a result, the driver 2 of the lead vehicle 10 drives the lead vehicle 10 in accordance with the instruction, and the driver 2 of each of one or more following vehicles 10 drives the subject vehicle 10 so as to follow the preceding vehicle 10 (including the lead vehicle 10) of the subject vehicle 10. In addition, the “manually driven vehicle” referred to herein may include, for example, a “driving assistance vehicle” having an automated driving function (i.e., driving assistance function) that enables partial automatic travel control (i.e., advanced driving assistance) of level 2 or lower in the automatic driving level defined by the Society of Automotive Engineers (SAE) in the United States. Also, in the example of the driving assistance vehicle, the driver 2 may use driving assistance control (for example, adaptive cruise control (ACC), lane following assistance control) when causing the subject vehicle 10 to follow the preceding vehicle 10.

Moreover, the vehicle 10 may be an automated driving vehicle that can perform automatic traveling. More specifically, the “automated driving vehicle” described herein has an automated driving function of level 3 or higher in the automated driving level described above. In the example of the automated driving vehicle, the management server 20 remotely controls the platooning of the individual vehicles 10 constituting the vehicle train T, for example. More specifically, the management server 20 transmits an instruction related to the platooning to a control device 14 (see FIG. 2) of each vehicle 10, for example. As a result, the control device 14 of each vehicle 10 controls a travel device 13 (see FIG. 2) in accordance with the instruction. Alternatively, the management server 20 may remotely control the travel device 13 of each vehicle 10 directly. Furthermore, the remote control of the platooning of the vehicles 10 by the management server 20 may be performed, for example, only for the lead vehicle 10 in the vehicle train T. In this example, the control device 14 of each of one or more following vehicles 10 controls the automated driving of the subject vehicle 10 so as to follow the preceding vehicle 10 (including the lead vehicle 10) of the subject vehicle 10.

FIG. 2 is a block diagram showing an example of the configuration of the vehicle 10 and the management server 20 according to the present embodiment.

As shown in FIG. 2, the vehicle 10 includes a communication device 11, sensor group 12, the travel device 13, the control device 14, and the human machine interface (HMI) device 15.

The communication device 11 communicates with the outside of the vehicle 10. The communication device 11 performs wireless communication with the management server 20 via a communication network 3, for example. The communication device 11 may include a vehicle-to-vehicle communication device that enables communication between the subject vehicle 10 and a surrounding vehicle 10 (i.e., vehicle-to-vehicle communication (V2V)).

The sensor group 12 includes a recognition sensor, a vehicle state sensor, and a position sensor, for example. The recognition sensor recognizes (detects) a situation around the vehicle 10. Examples of the recognition sensor include a camera, a laser imaging detection and ranging (LIDAR), and a radar. The vehicle state sensor detects the state of the vehicle 10. Examples of the vehicle state sensor include a speed sensor, an acceleration sensor, a yaw rate sensor, and a steering angle sensor. The position sensor detects a position and an orientation of the vehicle 10. For example, the position sensor includes a global navigation satellite system (GNSS) receiver.

The travel device 13 is a device that operates the vehicle 10. The travel device 13 includes a drive device, a brake device, and a steering device. The drive device includes, for example, at least one of an electric motor and an internal combustion engine for driving (accelerating) the vehicle 10. The brake device includes a brake actuator for braking (decelerating) the vehicle 10. The steering device includes an electric motor for turning the wheels of the vehicle 10.

The control device 14 controls the vehicle 10. The control device 14 includes one or more processors 16 (hereinafter, simply referred to as a processor 16) and one or more memory devices 17 (hereinafter, simply referred to as a memory device 17). The processor 16 executes various kinds of processing. Examples of the processor 16 include a general-purpose processor, a special-purpose processor, a central processing unit (CPU), a graphics processing unit (GPU), an application specific integrated circuit (ASIC), and a field-programmable gate array (FPGA). The processor 16 may also be referred to as processing circuitry. The memory device 17 stores various kinds of information. Examples of the memory device 17 include a volatile memory, a nonvolatile memory, a hard disk drive (HDD), and a solid state drive (SSD). The processor 16 executes a vehicle management program (computer program) including a vehicle control program. The vehicle management program is stored in the memory device 17. Alternatively, the vehicle management program may be recorded in a non-transitory computer-readable recording medium or may be provided via the communication network 3. The function of the control device 14 may be realized by cooperation between the processor 16 that executes the vehicle management program and the memory device 17.

The various kinds of information stored in the memory device 17 includes vehicle information Iv and travel preference information Ipv. The vehicle information Iv is information on the vehicle 10, and includes, for example, vehicle state information, surrounding situation information, position information, vehicle type information, and travel distance information. The vehicle state information is information indicating the state of the vehicle 10, such as the vehicle speed (travel speed), the acceleration, and the yaw rate, and is acquired using, for example, the sensor group 12 (vehicle state sensor). The surrounding situation information is information indicating the surrounding situation of the vehicle 10, and is acquired using, for example, the sensor group 12 (recognition sensor). The surrounding situation information may include object information regarding objects (for example, other vehicles, white lines, traffic lights, signs, roadside structures) around the vehicle 10. The position information is information indicating the position and the orientation of the vehicle 10, and is acquired using, for example, the sensor group 12 (position sensor). The vehicle type information is information indicating the type of the vehicle 10 (for example, passenger car, truck, or bus). The travel preference information Ipv will be described below.

The HMI device 15 is an interface between the vehicle 10 and the occupant 2 and is mounted on the vehicle 10, for example. Specifically, the HMI device 15 includes an output unit that outputs information to the occupant 2 and an input unit (for example, a touch panel, an operation button, an operation switch, a microphone) to which information is input by the occupant 2. The output unit includes, for example, a display device and a speaker. The display device is, for example, a display (for example, a meter panel) mounted on an instrument panel of the vehicle 10 or a head-up display (HUD) that displays information on a windshield of the vehicle 10. The HMI device 15 notifies the occupant 2 of various kinds of information based on an instruction from the control device 14. Also, the HMI device 15 transmits information input by the occupant 2 to the control device 14. The HMI device 15 may have a navigation function of guiding the traveling of the vehicle 10. In addition, a mobile device (for example, a smartphone or a tablet terminal) of the occupant 2 may be communicably connected to the control device 14 in a wired or wireless manner, for example, and may function as the HMI device 15.

As illustrated in FIG. 2, the management server 20 includes a communication device 21, one or more processors 22 (hereinafter, simply referred to as a processor 22), and one or more memory devices 23 (hereinafter, simply referred to as a memory device 23). The communication device 21 performs wireless communication with the vehicle 10 via the communication network 3.

The processor 22 executes various kinds of processing for supporting the platooning of the plurality of vehicles 10. Examples of the processor 22 include a CPU, a GPU, an ASIC, and an FPGA. The processor 22 may also be referred to as processing circuitry. The memory device 23 stores various kinds of information. Examples of the memory device 23 include a volatile memory, a nonvolatile memory, an HDD, and an SSD. The processor 22 executes a travel support program (computer program). The travel support program is stored in the memory device 23. Alternatively, the travel support program may be recorded in a non-transitory computer-readable recording medium or may be provided via the communication network 3. The function of the management server 20 may be realized by cooperation between the processor 22 that executes the travel support program and the memory device 23.

The various kinds of information stored in the memory device 23 includes the travel preference information Ipv, vehicle train information It, and map information. The travel preference information Ipv is acquired from each vehicle 10. The vehicle train information It includes, for each vehicle train T, a vehicle train identification (ID), vehicle train travel information Itt, travel preference information Ipt, and vehicle train surrounding situation information Its, for example. The vehicle train travel information Itt is information indicating the traveling state of the vehicle train T, and includes, for example, the position, the travel speed, and the number of lane changes of the vehicle train T. The vehicle train travel information Itt can be acquired based on the vehicle information Iv from each vehicle 10, for example. The travel preference information Ipt is information indicating the travel preference of the vehicle train T, and can be specified by, for example, a method described in step S11 described below. The vehicle train surrounding situation information Its is information indicating the surrounding situation of the vehicle train T, and includes, for example, information of surrounding vehicles (including emergency vehicles) of the vehicle train T and road traffic information (for example, traffic density, traffic volume, congestion, traffic regulation, and traffic accidents). The vehicle train surrounding situation information Its can be acquired based on, for example, the vehicle information Iv (surrounding situation information) from each vehicle 10 or information from an external system (for example, a road traffic information providing system). The map information includes information (for example, road shape and lane information) of a road on which the vehicle train T travels.

### 2. Processing Related to Platooning Support

Here, processing for supporting the formation of the vehicle train T that performs the platooning will be described. That is, in the preference information acquisition processing, the management server 20 acquires the “travel preference information Ipv” from each of the plurality of vehicles 10 that are targets of the platooning support. Then, in the vehicle train formation support processing, the management server 20 supports the formation of the vehicle train T in which vehicles 10 having similar travel preferences among the plurality of vehicles 10 perform the platooning, based on the acquired travel preference information Ipv.

The travel preference information Ipv is information indicating the preference of the occupant 2 (e.g., the driver) regarding the traveling of the vehicle 10. In detail, the travel preference information Ipv includes at least travel pattern preference information Ipv1. The travel pattern preference information Ipv1 relates to a desired travel pattern of the occupant 2. The travel pattern can also be referred to as a travel mode.

Moreover, the travel preference information Ipv may include, for example, destination preference information Ipv2 on a desired destination together with the travel pattern preference information Ipv1. Alternatively, the travel preference information Ipv may include travel speed preference information Ipv3 on a desired travel speed together with the travel pattern preference information Ipv1. Furthermore, the travel preference information Ipv may include both the destination preference information Ipv2 and the travel speed preference information Ipv3 together with the travel pattern preference information Ipv1.

### (Desired Travel Pattern)

The desired travel pattern may include, for example, any two or more of a “travel efficiency priority pattern”, a “safety priority pattern”, a “fuel efficiency priority pattern”, and an “on-time observance priority pattern” as candidates for selection by the occupant 2. The travel efficiency priority pattern is a pattern that focuses on traveling to reach a destination earlier (for example, aggressively performing overtaking). The safety priority pattern is a pattern that focuses on traveling to arrive at a destination more safely (for example, allowing an arrival delay of less than a designated time). The fuel efficiency priority pattern is a pattern that focuses on low fuel-efficient traveling. The on-time observance priority pattern is a pattern that focuses on traveling on time (for example, arriving at each location at a designated point of time as in a route bus).

Moreover, the desired travel pattern may be specified by at least one of the preference of a “lane change frequency” and the preference of a “speed range”, for example. The lane change frequency mentioned here is the number of lane changes per designated time, and the speed range is the magnitude of the allowable speed difference with respect to a target speed set when the vehicle 10 is traveling.

The travel pattern preference information Ipv1 may be acquired in advance in each of the vehicles 10 by the following method. That is, for example, the control device 14 of each vehicle 10 may request the occupant 2 to select (input) a desired travel pattern through the HMI device 15. More specifically, for example, the control device 14 may request the occupant 2 to select a desired travel pattern from designated candidates (for example, the travel efficiency priority pattern and the safety priority pattern). Alternatively, the control device 14 may request the occupant 2 to input a numerical value that matches the preference of the occupant 2 from among numerical values of the lane change frequency determined in advance, for example. This is the same for the speed range.

Furthermore, the control device 14 stores the desired travel pattern selected (input) by the occupant 2 as described above in the memory device 17 as the travel pattern preference information Ipv1. Alternatively, the control device 14 may specify the desired travel pattern based on the travel record of the vehicle 10 driven by the occupant 2 in the past and store the specified desired travel pattern in the memory device 17 as the travel pattern preference information Ipv1. In addition, machine learning may be used to specify the desired travel pattern in this manner.

Additionally, it can be said that the desired travel pattern described above indicates the priority of the occupant 2 for the traveling (driving) of the vehicle 10.

### (Desired Destination)

The destination preference information Ipv2 may be acquired in advance in each of the vehicles 10 by the following method. That is, for example, the control device 14 may request the occupant 2 to select (input) a desired destination through the HMI device 15. When the desired destination is input to the HMI device 15, the control device 14 stores the input desired destination in the memory device 17 as the destination preference information Ipv2.

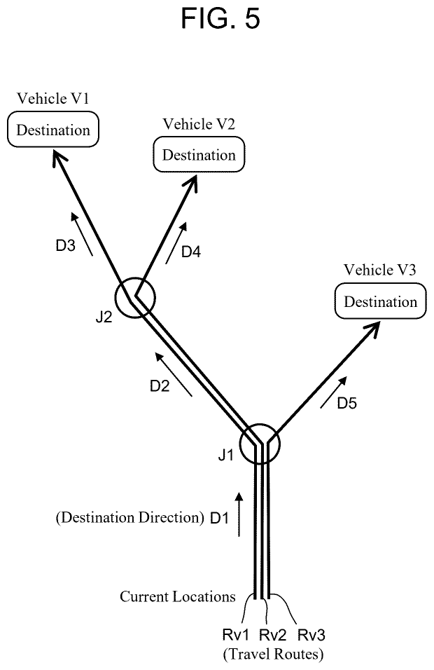

Moreover, the HMI device 15 may include a processor configured to generate a travel route Rv of the vehicle 10 based on the position information on the current location and the destination of the vehicle 10 and the map information. Also, the information on the desired destination as the destination preference information Ipv2 may be a “destination direction (for example, see FIG. 5 described below)” specified by the travel route Rv to the destination.

### (Desired Travel Speed)

The travel speed preference information Ipv3 in each of the vehicles 10 may be acquired in advance by, for example, the following method. That is, the control device 14 may request the occupant 2 to select (input) a desired travel speed through the HMI device 15. More specifically, the control device 14 may request the occupant 2 to input a numerical value of the desired travel speed (for example, 80 km/h, 100 km/h). Alternatively, the control device 14 may request the occupant 2 to select a desired travel speed as a rough speed range (for example, low speed, medium speed, high speed) instead of a specific numerical value (i.e., a set speed) of the desired travel speed. Then, the control device 14 may store the desired travel speed input (selected) by the occupant 2 in the memory device 17 as the travel speed preference information Ipv3. Alternatively, for example, the control device 14 may specify the desired travel speed based on the travel record of the vehicle 10 during the past driving by the occupant 2 and store the specified desired travel speed in the memory device 17 as the travel speed preference information Ipv3.

### (Others)

The travel preference information Ipv may include information indicating a preference of the occupant 2 regarding other elements other than the desired travel pattern, the desired destination, and the desired travel speed. The other elements may be, for example, characteristics of the vehicles 10 constituting the vehicle train T. More specifically, the travel preference information Ipv may include, for example, information indicating a preference for platooning in which only vehicles 10 of the same type (e.g., trucks or passenger cars) are included, and a preference for platooning in which vehicles 10 of different types are allowed to be mixed. Furthermore, the other elements may be, for example, vehicle-to-vehicle information (more specifically, vehicle-to-vehicle time or vehicle-to-vehicle distance) with the preceding and following vehicles 10 during the platooning, and thus the travel preference information Ipv may include information indicating a preference regarding the length of the vehicle-to-vehicle time or the vehicle-to-vehicle distance.

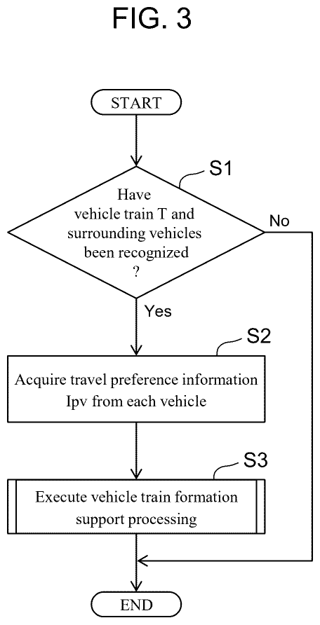

FIG. 3 is a flowchart showing an example of the flow of the preference information acquisition processing and the vehicle train formation support processing according to the present embodiment. The processing of this flowchart is executed to support the vehicle 10 having a travel preference close to that of the vehicle train T to join the vehicle train T. When there is a plurality of vehicle trains T, the management server 20 executes the processing of this flowchart for each vehicle train T.

Additionally, the vehicle train T subject to the processing in FIG. 3 is an expression indicating not only a vehicle train (that is, the collection of a plurality of vehicles 10) itself formed after two or more vehicles 10 are first gathered, but also one vehicle 10 served as the center when the two or more vehicles 10 are first gathered for vehicle train formation. The one vehicle 10 serving as the center may be specified as follows, for example. That is, the management server 20 may specify a vehicle having the standard travel preference information Ipv among the two or more vehicles 10 as the one vehicle 10 serving as the center.

In FIG. 3, in step S1, the management server 20 (processor 22) determines whether or not the vehicle train T and one or more surrounding vehicles 10 of the vehicle train T have been recognized. Specifically, the management server 20 specifies the vehicle train T that is the target of the processing this time based on the vehicle train information It. Then, the management server 20 executes processing of recognizing one or more of surrounding vehicles 10 with respect to the vehicle train T on the basis of, for example, the position information of the specified vehicle train T and the position information of the surrounding vehicles 10 that do not currently form a vehicle train. In addition, the one or more surrounding vehicles 10 may include not only one or more vehicles 10 that are traveling but also one or more vehicles 10 that are stopped at a place, such as a service area.

When one or more surrounding vehicles 10 with respect to the vehicle train T are not recognized (step S1; No), the processing proceeds to “END”. On the other hand, when one or more surrounding vehicles 10 are recognized (step S1; Yes), the processing proceeds to step S2. The processing of steps S2 and S3 may be executed when the management server 20 receives requests from one or more surrounding vehicles 10 requesting to join the vehicle train T, instead of the processing of step S1.

In step S2, the management server 20 acquires the travel preference information Ipv from each of the vehicles 10 constituting the vehicle train T and each of the recognized one or more surrounding vehicles 10 (preference information acquisition processing). The acquired travel preference information Ipv is stored in the memory device 23. Thereafter, the processing proceeds to step S3.

In step S3, the management server 20 executes the vehicle train formation support processing. The vehicle train formation support processing is executed as follows, for example.

### First Example

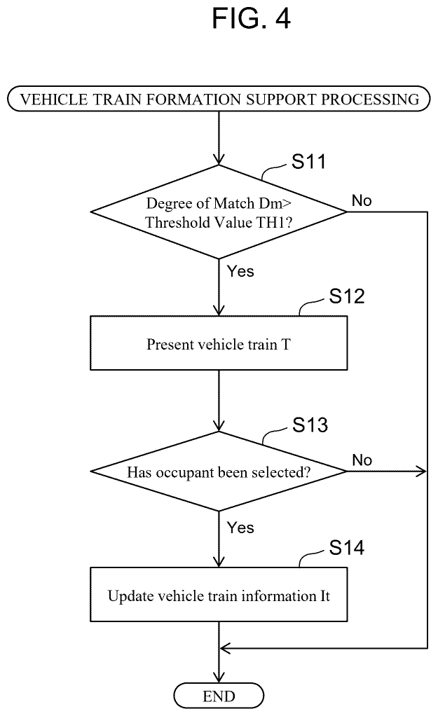

FIG. 4 is a flowchart showing the first example of the flow of the vehicle train formation support processing in step S3. When a plurality of surrounding vehicles 10 are recognized, the processing shown in FIG. 4 is executed for each of the surrounding vehicles 10.

In FIG. 4, in step S11, the management server 20 determines whether or not the degree of match Dm between the travel preference information Ipt of the vehicle train T and the travel preference information Ipv of the surrounding vehicle 10 is higher than a designated threshold value TH1, which corresponds to the “first threshold value” according to the present disclosure. In addition, in step S11, when two or more vehicles 10 are first gathered to form the vehicle train T, the degree of match Dm of the travel preference information Ipv between one vehicle 10 serving as the center of the vehicle train formation and the surrounding vehicle 10 is compared with the threshold value TH1.

The degree of match Dm may be quantified in the form of a score SC, for example. For example, the score SC may be calculated to be 0 when the travel preference information Ipt and the travel preference information Ipv completely match each other, and to be greater when the difference between the travel preference information Ipt and the travel preference information Ipv is greater. That is, the degree of match Dm increases when the score SC approaches 0. Therefore, the management server 20 determines that the degree of match Dm is higher than the threshold value TH1 when the score SC is lower than a designated threshold value.

To be more specific, in an example in which the travel preference information Ipv includes the travel pattern preference information Ipv1, the destination preference information Ipv2, and the travel speed preference information Ipv3, the management server 20 may calculate scores SC1, SC2, and SC3 corresponding to the respective degrees of match Dm1, Dm2, and Dm3, and calculate the sum of the calculated scores SC1, SC2, and SC3 as the score SC. Further, as shown in Equation 1 described below, the scores SC1, SC2, and SC3 may be multiplied by the respective coefficients K (e.g., K1, K2, and K3). Then, the coefficients K may be determined such that the value of one coefficient K corresponding to the preference information of which the degree of reflection on the score SC is desired to be increased is greater than the value of at least one of other coefficients K. For example, in order to increase the degree of reflection of the travel pattern preference information Ipv1 on the score SC, the coefficient K1 may be determined to be greater than at least one of the other coefficients K2 and K3.

$$SC = SC 1 \times K 1 + SC 2 \times K 2 + SC 3 \times K 3 \qquad ( 1 )$$

FIG. 5 is a supplementary diagram regarding the degree of match Dm2 of the destination preference information. FIG. 5 illustrates an example of travel routes Rv1, Rv2, and Rv3 of three vehicles 10 (referred to as vehicles V1, V2, and V3). In FIGS. 5, J1 and J2 are junctions at which the vehicle travel directions diverge. In the example illustrated in FIG. 5, the travel route Rv1 includes destination directions D1, D2, and D3, the travel route Rv2 includes destination directions D1, D2, and D4, and the travel route Rv3 includes destination directions D1 and D5. In this example, when viewed from the vehicle V1, it can be said that the preference of “destination direction” (destination preference information Ipv2) of the vehicle V2 having a large number of common destination directions (in other words, having a long platooning available section) is closer to that of the vehicle V1 than that of the vehicle V3. Therefore, in an example in which the information of the destination direction is used as the destination preference information Ipv2, the degree of match Dm2 may be determined as follows, for example. That is, when, for example, the destination preference information Ipt2 of the vehicle train T is equal to the destination preference information Ipv2 of the vehicle V1 in FIG. 5, the degree of match Dm2 between the destination preference information Ipt2 and the destination preference information Ipv2 of the vehicle V2 may be determined to be higher than the degree of match Dm2 between the destination preference information Ipt2 and the destination preference information Ipv2 of the vehicle V3.

The travel preference information Ipt (Ipt1 to Ipt3) of the vehicle train T used in step S11 can be determined as follows based on the travel preference information Ipv (Ipv1 to Ipv3) of the individual vehicles 10 constituting the vehicle train T. That is, for example, a statistical value (for example, a mean value, a variance, or a deviation (an average deviation or a standard deviation)) calculated from the quantified travel preference information Ipv of each of the vehicles 10 constituting the vehicle train T may be used as the travel preference information Ipt of the vehicle train T.

Additionally, the travel pattern preference information Ipt1 of the vehicle train T may be determined as follows. That is, as can be seen from the processing shown in FIG. 4, it can be said that the individual vehicles 10 constituting the vehicle train T have the travel pattern preference information Ipv1 with a high degree of match Dm1. Therefore, when the desired travel pattern is common to all the constituent vehicles 10, the management server 20 may determine the common desired travel pattern (for example, the travel efficiency priority pattern) as the travel pattern preference information Ipt1 (that is, the desired travel pattern of the vehicle train T). Further, even when the desired travel pattern is not common to all the constituent vehicles 10, the management server 20 may determine, as the travel pattern preference information Ipt1, a desired travel pattern that is common to the largest number of constituent vehicles 10 among all the constituent vehicles 10. This is the same for the other destination preference information Ipt2 and the travel speed preference information Ipt3 of the vehicle train T.

In FIG. 4, when the degree of match Dm is equal to or lower than the threshold value TH1 (step S11; No), the processing proceeds to “END”. That is, the management server 20 excludes the surrounding vehicle 10 that is a target of the determination in step S11 this time from consideration for joining the vehicle train T. In addition, when the management server 20 does not find any of the surrounding vehicles 10 having the degree of match Dm higher than the threshold value TH1, the management server 20 may perform the processing illustrated in FIG. 4 again for one or more surrounding vehicles 10 recognized in the processing of step S1 while lowering the threshold value TH1.

On the other hand, when the degree of match Dm is higher than the threshold value TH1 (step S11; Yes), the processing proceeds to step S12. In step S12, the management server 20 presents, to the surrounding vehicle 10 that is a target of the determination in step S11 this time, the vehicle train T as a candidate of vehicle train that the surrounding vehicle 10 joins (in other words, as a candidate for cooperatively performing the platooning). The presentation of the vehicle train T is performed for the occupant 2 of the surrounding vehicle 10 through the HMI device 15. The presentation of the vehicle train T is performed, for example, with information necessary for the occupant 2 to determine whether to participate in the vehicle train T. Examples of the information include information on the degree of match Dm of the travel preference information between the vehicle train T and the subject vehicle 10, and information on the time needed for the subject vehicle 10 to reach the vehicle train T.

In step S13 subsequent to step S12, the management server 20 determines whether or not the management server 20 has received intention expression information indicating that the occupant 2 selected to join the vehicle train T from the surrounding vehicle 10 that received the presentation of the vehicle train T.

When the intention expression information is not received within a designated time from the presentation of the vehicle train T (step S13; No), the process proceeds to “END”. On the other hand, when the intention expression information is received (step S13; Yes), the processing proceeds to step S14. In step S14, the management server 20 updates the vehicle train information It such that information of the surrounding vehicle 10 that has transmitted the intention expression information is added.

### Second Example

According to the first example described above, even if a vehicle train T having the degree of match Dm with the vehicle 10 that is higher than the threshold value TH1 is found, the vehicle train T may be traveling at a position far from the vehicle 10. The occupant 2 of the vehicle 10 may desire to select another vehicle train T that is closer to the position of the vehicle 10 even if the degree of match Dm is lower than that of the vehicle train T.

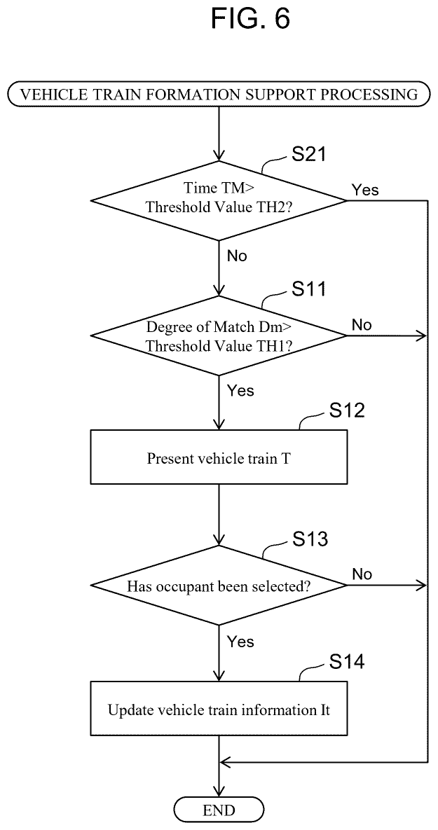

Accordingly, the vehicle train formation support processing may be executed as in the following second example. FIG. 6 is a flowchart showing the second example of the flow of the vehicle train formation support processing in step S3.

In step S21, the management server 20 determines whether or not a time TM for the vehicle 10 to reach the vehicle train T is longer than a designated threshold value TH2, which corresponds to the “second threshold value” according to the present disclosure. Specifically, the management server 20 calculates the time TM based on, for example, the vehicle information Iv (position and travel speed) and the vehicle train travel information Itt (position and travel speed) acquired from the vehicle 10.

When the time TM is longer than the threshold value TH2 (step S21; Yes), the processing proceeds to “END”. That is, the management server 20 excludes the vehicle train T recognized this time by the processing of step S1 from the candidate of the vehicle train T presented to the vehicle 10 which is a target of the vehicle train formation support processing this time. On the other hand, when the time TM is equal to or shorter than the threshold value TH2 (step S21; No), the degree of match Dm between the vehicle train T and the vehicle 10 is determined (step S11).

According to the vehicle train formation support processing described above, it is possible to support the formation of the vehicle train T in which the travel preference of the occupant 2 of the vehicle 10 participating in the vehicle train T is appropriately satisfied. Thus, the occupant 2 of the vehicle 10 can obtain a benefit by participating in the vehicle train T while reducing the degree of sacrificing the travel preference of the occupant 2. More specifically, according to the vehicle train formation support processing of the present embodiment, the desired travel pattern is considered as the travel preference. Therefore, the formation of the vehicle train T can be supported such that the travel preference of the occupant 2 is appropriately satisfied.

Moreover, according to the vehicle train formation support processing of the present embodiment, when at least one of the desired destination and the desired travel speed is further considered together with the desired travel pattern as the travel preference, the formation of the vehicle train T can be supported such that the travel preference of the occupant 2 is more appropriately satisfied.

Furthermore, according to the second example (see FIG. 6) of the vehicle train formation support processing, the occupant 2 of the vehicle 10 can select a vehicle train T from the presented candidates also in consideration of the time TM for the vehicle 10 to reach the vehicle train T (that is, the temporal distance to the vehicle train T).

Moreover, the processing of step S1 (see FIG. 3) may be executed to recognize a plurality of vehicle trains T. Then, in the vehicle train formation support processing, the management server 20 may specify a plurality of candidates of the vehicle train T to be presented to the occupant 2 of the surrounding vehicle 10 and present the plurality of specified candidates to the occupant 2. Thus, the occupant 2 can select a vehicle train T to be joined from among a plurality of candidates. Therefore, the occupant 2 can more actively select a vehicle train T that more suitably satisfies his/her expectation.

### (Merging Support Processing)

Furthermore, the vehicle train formation support processing may include a “merging support processing” that, after an occupant 2 selects to join a vehicle train T, supports the vehicle 10 of the occupant 2 to travel to join the vehicle train T. Specifically, in an example in which the vehicle 10 is a manually driven vehicle (including the driving assistance vehicle described above), the merging support processing may include, for example, notifying the occupant 2 of at least one of a notification of a travel route until the vehicle 10 joins the vehicle train T, an instruction of lane change, and an instruction of a travel speed, through the HMI device 15. Further, in an example in which the vehicle 10 is the automated driving vehicle described above, the merging support processing may include, for example, that the management server 20 remotely controls the traveling of the vehicle 10 until the vehicle 10 joins the vehicle train T. According to the merging support processing, even when the vehicle 10 selected to join the vehicle train T is, for example, far from the vehicle train T, the management server 20 that knows the position information of the vehicle 10 and the vehicle train T can smoothly guide the vehicle 10 to the vehicle train T.

### 3. Further Processing Related to Platooning Support

For the platooning support, the management server 20 may additionally execute at least one of “first vehicle train reconstitution processing” and “second vehicle train reconstitution processing” described below.

### 3-1. First Vehicle Train Reconstitution Processing

When the vehicle train T is too long, the influence of the vehicle train T on the surrounding vehicles increases, and it also becomes difficult to control the vehicle train T. Therefore, if the vehicle train T is too long even when the vehicle train T having similar travel preference information is present near the vehicle 10, it is not appropriate to cause the vehicle 10 to simply participate in the vehicle train T.

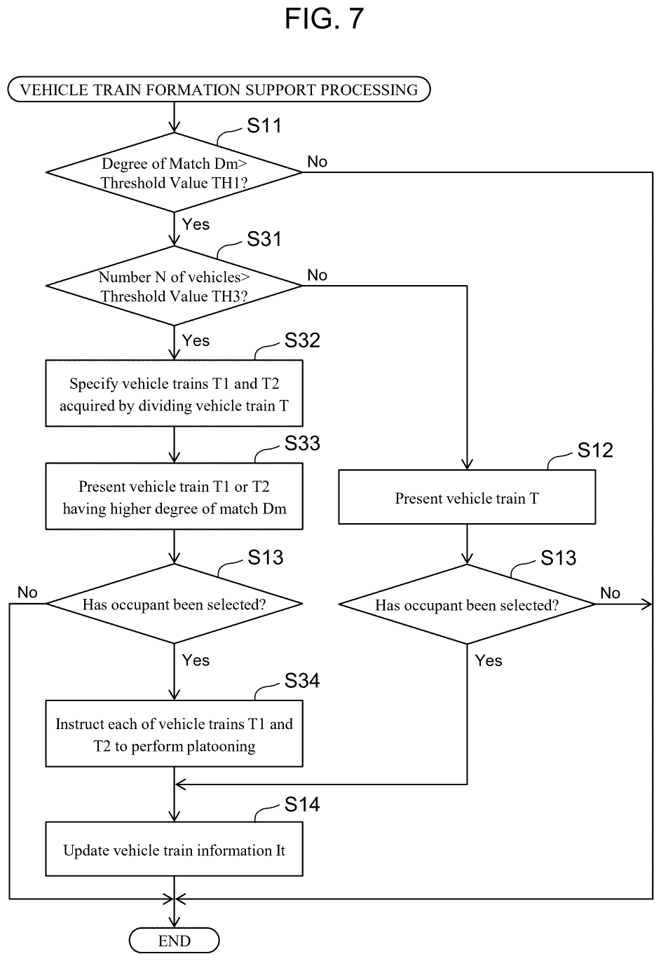

Accordingly, the management server 20 may execute the above-described “vehicle train formation support processing” along with the following “first vehicle train reconstitution processing”. FIG. 7 is a flowchart showing an example of the flow of the vehicle train formation support processing accompanied by the first vehicle train reconstitution processing. In addition, in FIG. 7, the first vehicle train reconstitution processing is combined with the vehicle train formation support processing shown in FIG. 4 but may be combined with the vehicle train formation support processing shown in FIG. 6 instead.

In FIG. 7, when the degree of match Dm is higher than the threshold value TH1 (step S11; Yes), the processing proceeds to step S31. In step S31, the management server 20 determines whether or not the number N of vehicles forming (i.e., constituting) the vehicle train T exceeds a designated threshold value TH3 if the surrounding vehicles 10 that are the determination targets of step S11 this time participate in the vehicle train T recognized this time by the processing of step S1. The threshold value TH3 corresponds to the “third threshold value” according to the present disclosure. The information on the number N of vehicles is included in the vehicle train travel information Itt described above, for example.

When the number N of vehicles does not exceed the threshold value TH3 (step S31; No), the same processing as the processing shown in FIG. 4 is executed. On the other hand, when the number N of vehicles exceeds the threshold value TH3 (step S31; Yes), the processing proceeds to step S32.

In step S32, the management server 20 executes processing of specifying two vehicle trains T1 and T2 acquired by dividing the vehicle train T (herein, also referred to as an “original vehicle train T0”). For example, the management server 20 determines the vehicles 10 belonging to each of the vehicle train T1 and the vehicle train T2 based on the respective positions of the vehicles 10 in the original vehicle train TO. For example, each of the vehicle train T1 and the vehicle train T2 is determined such that the vehicles 10 located close to each other gather. Further, for example, the vehicles 10 belonging to each of the vehicle trains T1 and T2 may be determined in consideration of the travel preference information Ipv such that the vehicles 10 having the travel preference information Ipv close to each other among the plurality of vehicles 10 included in the original train T0 gather. In addition, the vehicle train T1 or T2 may be treated as the original vehicle train T0.

In step S33 subsequent to step S32, the management server 20 calculates the degree of match Dm between each of the specified vehicle trains T1 and T2 and the surrounding vehicle 10 that is the determination target of step S11 this time. Then, the management server 20 presents the vehicle train T1 or T2 having the higher degree of match Dm as a candidate of the vehicle train T to which the surrounding vehicle 10 joins. Thereafter, when the occupant 2 selects to join the presented vehicle train T1 or T2 (step S13; Yes), the processing proceeds to step S34.

In step S34, the management server 20 instructs each of the vehicle trains T1 and T2 specified in step S32 to perform the platooning as one vehicle train. That is, the management server 20 instructs the vehicles 10 included in the vehicle train T1 (more specifically, each vehicle 10 or the lead vehicle 10) to perform the platooning as the vehicle train T1. Similarly, the management server 20 instructs the vehicles 10 included in the vehicle train T2 (more specifically, each vehicle 10 or the lead vehicle 10) to perform the platooning as the vehicle train T2. The instruction includes an instruction for requesting the vehicles 10 included in the vehicle train T1 or T2 to change lanes from the travel lane of the original vehicle train T0.

Additionally, although the example in which the original vehicle train T0 is divided into the two vehicle trains T1 and T2 has been described here, the first vehicle train reconstitution processing may be executed such that the original vehicle train T0 is divided into three or more vehicle trains. When the original vehicle train T0 is divided into three or more vehicle trains, a vehicle train having the highest degree of match Dm with the surrounding vehicle 10 among the three or more vehicle trains is presented as a candidate to the occupant 2 of the surrounding vehicle 10.

According to the vehicle train formation support processing accompanied by the first vehicle train reconstitution processing described above, the formation of the vehicle train T can be supported such that the travel preferences of the occupants 2 of the respective vehicles 10 participating in the vehicle train T are appropriately satisfied while preventing the vehicle train T from becoming too long. Further, the first vehicle train reconstitution processing does not simply reject the participation of the surrounding vehicle 10 in the vehicle train T in which the number N of vehicles exceeds the threshold value TH3. Therefore, the surrounding vehicle 10 does not lose an opportunity to participate in the vehicle train T expected by the occupant 2.

### 3-2. Second Vehicle Train Reconstitution Processing

When the number N of vehicles constituting the vehicle train T is too large, the variation in the travel preference among the constituent vehicles 10 may be increased. As a result, it may become difficult to satisfy the overall travel preference of the constituent vehicle 10 by one vehicle train T.

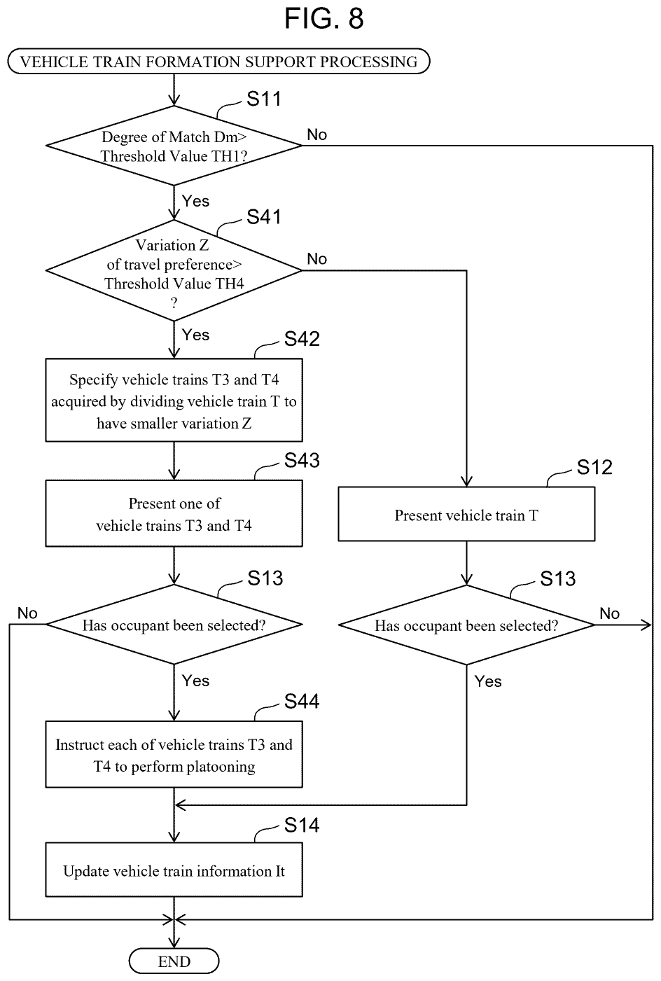

Accordingly, the management server 20 may execute the above-described “vehicle train formation support processing” along with the following “second vehicle train reconstitution processing”. FIG. 8 is a flowchart showing an example of the flow of the vehicle train formation support processing accompanied by the second vehicle train reconstitution processing. In addition, in FIG. 8, the second vehicle train reconstitution processing is combined with the vehicle train formation support processing shown in FIG. 4 but may be combined with the vehicle train formation support processing shown in FIG. 6 instead.

In FIG. 8, when the degree of match Dm is higher than the threshold value TH1 (step S11; Yes), the processing proceeds to step S41. In step S41, the management server 20 determines whether or not a variation Z in the travel preference information Ipv among the plurality of vehicles 10 included in the vehicle train T exceeds a designated threshold value TH4 if the surrounding vehicle 10 that is the determination target of step S11 participates in the vehicle train T recognized this time by the processing of step S1. The threshold value TH4 corresponds to the “fourth threshold value” according to the present disclosure. This determination can be made as follows, for example. That is, when there is a vehicle 10 in the vehicle train T whose degree of match Dm is lower than a designated threshold value with one vehicle 10 serving as the center of the vehicle train T as a reference, the management server 20 may determine that the variation Z exceeds the threshold value TH4.

In addition, in an example in which the score SC2 corresponding to the degree of match Dm2 related to the destination preference information Ipv2 indicates the preference of the “destination direction” as described with reference to FIG. 5, the score SC which is a basis of the degree of match Dm for determining the variation Z may be calculated as shown in Equation 2. That is, the score SC may be obtained by, for example, dividing the sum of “the product of the score SC1 and the coefficient K1 regarding the travel pattern” and “the product of the score SC3 and the coefficient K3 regarding the travel speed” by “the product of the score SC2 and the coefficient K2 regarding the destination”. According to Expression 2, when the sum “SC1×K1+SC3×K3” in Expression 2 is the same, the score SC is greater when the score SC2 is small (that is, when the number of common destination directions is large (in other words, when the platooning available section is long)) than when the score SC2 is great (that is, when the remaining platooning available section is small). As described above, the degree of match Dm increases when the score SC approaches 0. Therefore, according to the score SC calculated by Equation 2, the variation Z can be determined as follows. That is, when the platooning available section of the vehicle train Tis longer, the determination regarding the variation Z (step S41) is more likely to be established (that is, the determination of the variation Z can be made more strictly). On the other hand, when the platooning available section is shorter (in other words, when the platooning is performed only for a shorter time), the vehicle train T is more likely to be maintained even if one or both of the other travel pattern preference information Ipv1 and the travel speed preference information Ipv3 are slightly different.

$$SC = ( SC 1 \times K 1 + SC 3 \times K 3 ) / ( SC 2 \times K 2 ) \qquad ( 2 )$$

When the variation Z does not exceed the threshold value TH4 (step S41; No), the same processing as the processing illustrated in FIG. 4 is executed. On the other hand, when the variation Z exceeds the threshold value TH4 (step S41; Yes), the processing proceeds to step S42.

In step S42, the management server 20 executes processing of specifying two vehicle trains T3 and T4 acquired by dividing the vehicle train T (herein, also referred to as the “original vehicle train T0”) such that the variation Z is smaller than that of the vehicle train T0. To be specific, the management server 20 searches the vehicle train TO for the constituent vehicles 10 of each of the vehicle trains T3 and T4 and determines the constituent vehicles 10 of each of the vehicle trains T3 and T4 such that the variation Z between the constituent vehicles 10 of each of the vehicle trains T3 and T4 is minimized. In addition, the vehicle train T3 or T4 may be treated as the original vehicle train T0.

In step S43 subsequent to step S42, the management server 20 presents one of the specified vehicle train T3 and the specified vehicle train T4 as a vehicle train candidate to which the surrounding vehicle 10 joins. For example, as in the processing of step S33, the management server 20 may present the vehicle train T3 or the vehicle train T4 having a higher degree of match Dm with the surrounding vehicle 10 that is a target of the determination of step S11 this time. Thereafter, when the occupant 2 selects to join the presented vehicle train T3 or T4 (step S13; Yes), the processing proceeds to step S44.

In step S44, the management server 20 instructs each of the vehicle trains T3 and T4 specified in step S42 to perform the platooning as one vehicle train. This processing is the same as the processing of step S34.

Additionally, although the example in which the original vehicle train T0 is divided into the two vehicle trains T3 and T4 has been described here, the second vehicle train reconstitution processing may be executed such that the original vehicle train T0 is divided into three or more vehicle trains. When the original vehicle train TO is divided into three or more vehicle trains, the management server 20 searches for and determines the constituent vehicles 10 of each of the three or more vehicle trains such that the variation Z between the constituent vehicles 10 is minimized in each of the three or more vehicle trains.

Furthermore, unlike the processing shown in FIG. 8, the second vehicle train reconstitution processing may be executed separately from the vehicle train formation support processing. That is, when the variation Z exceeds the threshold value TH4 (step S41; Yes), the management server 20 may present the vehicle train T (i.e., the original vehicle train T0) as a candidate to the occupant of the surrounding vehicle 10, for example. Then, the management server 20 may execute the second vehicle train reconstitution processing (the same processing as the processing of steps S42 and S44) for a vehicle train T after the surrounding vehicle 10 joins.

The second vehicle train reconstitution processing executed as described above corresponds to processing for dividing the vehicle train T into at least two vehicle trains (for example, T3 and T4) such that the at least two vehicle trains having a smaller variation Z than the vehicle train T (the original vehicle train T0) are acquired. As a result, for example, the platooning of the vehicle train T can be supported while reducing the variation Z in the travel preference information Ipv of each vehicle 10 included in the vehicle train T such that the variation Z does not become excessive due to the participation of a new vehicle 10 in the vehicle train T. In addition, when the vehicle train formation support processing is executed in association with the second vehicle train reconstitution processing, the formation of the vehicle train T can be supported such that the travel preference of the occupant 2 of each vehicle 10 participating in the vehicle train T is appropriately satisfied while reducing the variation Z so as not to become excessive as described above.

The various kinds of processing related to the platooning support described above may be executed as follows. That is, instead of the management server 20 of the travel support system 1, for example, “one more processors (processing circuitry)” mounted on one vehicle 10 which serves as the center of the vehicle train T may execute the various kinds of processing using the vehicle-to-vehicle communication. In this example, a device (e.g., at least one of the control device 14 and the HMI device 15) including the one or more processors mounted on the vehicle 10 corresponds to another example of the “travel support device” according to the present disclosure.

What is claimed is:

1. A travel support device that supports platooning of vehicles, comprising processing circuitry configured to:
acquire, from a target vehicle, travel preference information indicating a preference of an occupant regarding vehicle traveling and including travel pattern preference information on a desired travel pattern; and
based on the acquired travel preference information, execute vehicle train formation support processing of supporting formation of a vehicle train that performs the platooning, wherein
the vehicle train formation support processing includes presenting the vehicle train as a candidate for cooperatively performing the platooning, to the occupant of the target vehicle through a human machine interface device of the target vehicle, when a degree of match of the travel preference information between the vehicle train and the target vehicle is higher than a first threshold value.

2. The travel support device according to claim 1, wherein
the travel preference information further includes at least one of destination preference information on a desired destination and travel speed preference information on a desired travel speed.

3. The travel support device according to claim 1, wherein
the vehicle train formation support processing further includes:
calculating a time for the target vehicle to reach the vehicle train based on information on a position and a travel speed of the target vehicle and information on a position and a travel speed of the vehicle train; and
excluding the vehicle train from the candidate when the time is longer than a second threshold value.

4. The travel support device according to claim 1, wherein
when a number of vehicles forming the vehicle train exceeds a third threshold value in response to participation of the target vehicle in the vehicle train, the processing circuitry specifies at least two vehicle trains acquired by dividing the vehicle train, and presents, as the candidate, a vehicle train having a highest degree of match with the target vehicle among the at least two vehicle trains, to the occupant of the target vehicle through the human machine interface device.

5. The travel support device according to claim 1, wherein
when a variation in the travel preference information between a plurality of vehicles included in the vehicle train exceeds a fourth threshold value, the processing circuitry executes processing of dividing the vehicle train into at least two vehicle trains so as to acquire the at least two vehicle trains having a smaller variation than the vehicle train.
